(19) United States
(12) Patent Application Publication
(10) Pub. No.: US 2007/0187495 A1
(43) Pub. Date: Aug. 16, 2007

(54) Automated rain check issue system

(76) Inventor: Ruth Mullins, Delray Beach, FL (US)

Correspondence Address: ROBERT M. DOWNEY, P.A., 6751 N. FEDERAL HWY., SUITE 300, BOCA RATON, FL, 33487, US

(21) Appl. No.: 11/704,620

(22) Filed: Feb. 9, 2007

Related U.S. Application Data
(60) Provisional application No. 60/772,392, filed on Feb. 10, 2006.

(51) Int. Cl. G06K 15/00; G06Q 30/00; G06Q 20/00

(52) U.S. Cl. 235/383; 235/385; 705/16

(57) ABSTRACT

A computer controlled system for issuing “rain checks” to customers in a retail store in order to allow future purchase of retail items at a currently advertised sales price in the event the “on sale” items are currently out of stock. The system includes a central processing unit (CPU), a digital scanner for entering specific sale item information for storage on the CPU unit, a monitor for displaying information stored on the CPU, including a list of items that are currently “on sale” and the current inventory of the “on sale” items in the store, and a printer for printing the “rain check” which identifies the out of stock “on sale” item and the sale price of that item.

This application is based on provisional patent application Ser. No. 60/772,392 filed on Feb. 10, 2006.

### BACKGROUND OF THE INVENTION

1. Field of the Invention

The invention relates to an inventory monitoring and printing system for a retail store and, more particularly, a system for the issuance of “rain checks” for retail items advertised as “on sale” that are currently out of stock.

2. Discussion of the Related Art

Most retail establishments will honor the sales price of items in the event a customer attempts to purchase any item that is currently on sale, but out of stock in the store's inventory. For instance, if a customer has an advertisement that shows a product as “on sale” for a specific reduced sale price at a retail store, and the customer goes to that store and attempts to purchase the “on sale” item only to find that the particular item is sold out (i.e. not on the shelf or in inventory), the customer may obtain a “rain check” from the store. The “rain checks” allows the customer to purchase that same item in the future at the currently advertised sale price. However, obtaining the “rain check” is not always a pleasant experience, either for the customer or store employee. In most stores, the customer must wait on line at the customer service counter in order to speak with a customer service representative (e.g. a store manager or assistant manager). Upon showing the advertisement to the customer service representative, it is then necessary to confirm that the item is “on sale” and out of stock. This can be a time consuming task which causes the store employee stress, as well as those customers who are waiting on line to speak to the customer service representative. Upon confirming that the item is on sale and not in stock, the customer service representative must then fill out a “rain check” form by writing appropriate information such as the product name, date and sale price on the “rain check”. In many instances, store employees will openly reveal their displeasure when a customer asks for a “rain check”. This makes many customers uncomfortable and reluctant to ask for a “rain check” on future occasions when a sale item is not in stock.

In view of the problems associated with the current method of issuing “rain checks” in retail stores, there remains a definite and urgent need for an automated computer controlled system that is adapted to quickly and easily verify all products on sale and their current inventory status in the store, and to print a “rain check” for a store customer in a very short period of time with minimal effort.

### OBJECTS AND ADVANTAGES OF THE INVENTION

Considering the foregoing, it is a primary object of the present invention to provide a system and method for issuing rain checks in retail stores with minimal effort on the part of a store employee and the customer, thereby eliminating stress and confirming accuracy of sale price and current inventory status.

It is still a further object of the present invention to provide a system and method for issuing rain checks in retail stores which identifies all items in a store that are currently “on sale,” confirms the sale price of the “on sale” items in the store, indicates the current inventory status of “on sale” items in the store and, further, which prints a rain check for a store customer when an “on sale” item is confirmed to be not in current inventory, there-by allowing the store customer to return to the store at a later date in order to purchase the “on sale” item at the sale price.

It is a further object of the present invention to provide a system and method for issuing raining checks to customers in retail stores in a quick and efficient manner, wherein a desired “on sale” item is checked in a computer inventory tracking program and, if confirmed that the “on sale” item is not in inventory, a rain check is instantly printed to identify the “on sale” item, the sale price and date, thereby allowing the customer to return to the store in the future and purchase the “on sale” item at the sale price.

It is still a further object of the present invention to provide a system and method for issuing rain checks to customers in retail stores, and wherein the system is easily operated by any store employee, at any location within the store, including at a check-out counter, thereby eliminating the need for a store customer to go to a separate customer service counter in order to obtain a rain check for an out of stock item that is “on sale”.

It is still a further object of the present invention to provide a computerized system and method for issuing rain checks to customers in retail stores, and wherein the computerized system monitors inventory levels of items sold in the store, confirms current inventory status of “on sale” items in the store along with the current sale price of the “on sale” items, and wherein the system prints a rain check at the request of a store customer when a desired “on sale” item is not in the store's current inventory.

These and other objects and advantages of the present invention are more readily apparent with reference to the following detailed description taken in conjunction with the accompanying drawings.

### SUMMARY OF THE INVENTION

The present invention is directed to a computer controlled system for issuing “rain checks” to customers in a retail store in order to allow future purchase of retail items at a currently advertised sales price in the event the “on sale” items are currently out of stock. The system includes a central processing unit (CPU), a digital scanner for entering specific sale item information for storage on the CPU unit, a monitor for displaying information stored on the CPU, including a list of items that are currently “on sale” and the current inventory of the “on sale” items in the store, and a printer for printing the “rain check” which identifies the out of stock “on sale” item and the sale price of that item.

### BRIEF DESCRIPTION OF THE DRAWINGS

For a fuller understanding of the nature of the present invention, reference should be made to the following detailed description taken in conjunction with the accompanying drawings in which:

FIG. 1 is a schematic diagram showing the principle components of the system of the present invention in accordance with a first preferred embodiment; and

FIG. 2 is a schematic diagram showing an arrangement of components of the system of the present invention in accordance with a second preferred embodiment.

Like reference numerals refer to like parts throughout the several views of the drawings.

### DETAILED DESCRIPTION OF THE PREFERRED EMBODIMENT

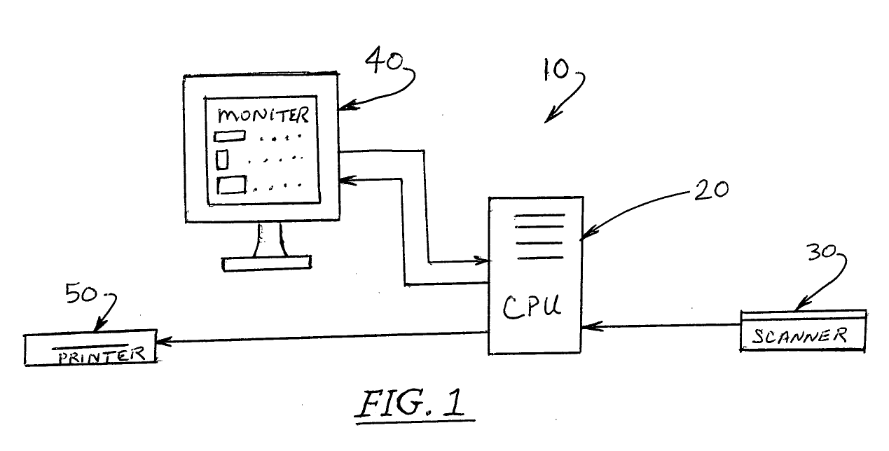

Referring to FIG. 1, the invention is directed to a system 10 for issuing “rain checks” to customers in a retail store which allows a customer to purchase items advertised as “on sale” at a future date in the event the particular item(s) is currently out of stock in the store's inventory.

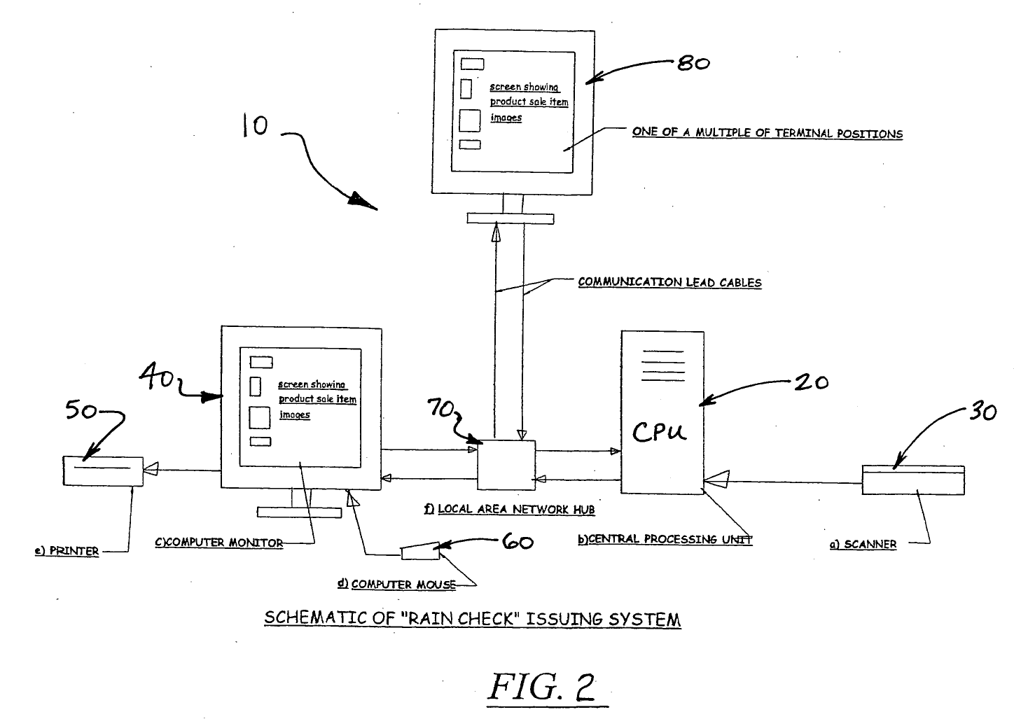

The system 10 consists of four primary components including a central processing unit (CPU) 20, a digital scanner 30, a monitor 40 and a digital printer 50. In a further embodiment, shown in FIG. 2, the system may include a computer mouse 60, a local area network hub 70 and a plurality of terminal monitors 80. The system provides a novel combination of components to better serve a retail store's customers through the automated issuance of “rain checks.” The system 10 eliminates a clerical task presently performed by store service personnel by hand (i.e. with the use of a pen) that requires the customer to spend time in a line at a customer service counter.

According to the system of the present invention, the store office/management personnel is charged with administering the “rain check” program. A store employee assigned to issue the “rain checks” enters the specific sale item information into the CPU 20 by means of a digital scanner 30. This can be done by scanning the UPC code on one of each “on sale” item in the store or by scanning the UPC code on a coupon for any “on sale” item. This information is stored on the CPU 20 memory for future access.

In the event a customer desires to purchase an “on sale” item and the item is not on the shelf in the store, the customer presents the customer service clerk or check-out clerk with the “on sale” advertisement for that particular item. The clerk accesses the screen on the monitor 40 or 80 which shows those items that are presently featured as “on sale.” Then the store clerk identifies the particular “on sale” item that the customer is attempting to purchase. The clerk highlights that item by touching the touch sensitive screen at the icon or other identifier that identifies the particular “on sale” item. This activity automatically verifies the inventory status of this particular item. If the particular “on sale” item is sold out, the system will display this information as either “sold out” or “out of stock” or some other indicator on the monitor 40/80. This verifies that the “on sale” item is, in fact, out of stock and prompts the store's automated inventory system to cue the re-ordering activity from the CPU 20. At the same time, the CPU 20 initiates the print command to the digital printer 50 in order to produce the “rain check” for the customer. The “rain check” displays the item name, size of the item, and sale price which is the current advertised “on sale” price. The “rain check” may also provide information such as the SKU number and/or UPC code for the particular item.

In a further embodiment of the system of the present invention, as shown in FIG. 2, a local area network hub 70 is used to allow placement of multiple terminal monitors 80 and printers 50 at one or more check-out stations in the store. This relieves the customer of the need to stand in a second line at a customer service counter in order to receive the “rain check” by, instead, producing the “rain check” along with the billing receipt for the customer at the check-out counter when the customer is paying for other products.

In a further embodiment, the system can be incorporated within the same unit with the check-out monitor and cashier receipt printer, as a single module, to produce the “rain check” with the customers purchase receipt at the time of payment for items being purchased at the check-out counter.

In still a further embodiment, each check-out station may be equipped with a wireless communication system (WiFi) connection to the CPU 20, thus eliminating the need for communication cables and a LAN hub.

In still a further embodiment of the invention, the CPU 20 and the scanner 30 may be located within the store or at some remote central location serving many stores in the same sales district.

While the invention has been shown and described in accordance with preferred and practical embodiments thereof, it is recognized that departures from the instant disclosure are contemplated within the spirit and scope of the invention.

What is claimed is:

1. A system for issuing rain checks to customers in a retail store comprising:
a central processing unit for storing and tracking inventory amounts of items sold in the store that are currently “on sale” along with a current sale price of each “on sale” item, and said central processing unit being structured and disposed for confirming inventory status of the “on sale” items and the current sale price of each “on sale” item;
a digital scanner for entering the current “on sale” items and the sale price of the “on sale” items into the central processing unit for storage therein;
a monitor for displaying information relating to the current “on sale” items and identifying each “on sale” item in the store and the sale price for each “on sale” item; and
a printer for printing a rain check for a customer when an “on sale” item desired to be purchased by the customer is not in the store's inventory, wherein the rain check identifies the “on sale” item, the sale price of the “on sale” item, and date of issue of the rain check.

2. The system as recited in claim 1 further comprising:
a local area network hub connecting the central processing unit to a plurality of monitors.

3. The system as recited in claim 1 wherein said monitor includes a touch sensitive screen for selecting and inputting data into the central processing unit identifying a selected “on sale” item and for inputting commands to the central processing unit including a print command to print the rain check by the printer.

4. A method for issuing rain checks to customers in a retail store comprising the steps of:
entering data relating to all items sold in the store that are “on sale,” including the identification of each “on sale” item and the sale price of each “on sale” item;
tracking the store's inventory levels of all of the “on sale” items;
confirming the store's inventory status of at least one “on sale” item at the request of a customer; and
printing a rain check for the customer after confirming that the at least one “on sale” item is no longer in inventory, thereby allowing the customer to return to the store in the future with the printed rain check in order to purchase the “on sale” item at the sale price.

5. The method as recited in claim 4 comprising the further step of:
displaying the current “on sale” items on a monitor.

6. The method as recited in claim 5 comprising the further step of:
displaying the current inventory level for all of the “on sale” items on the monitor.
